(19) United States
(12) Patent Application Publication
(10) Pub. No.: US 2026/0218861 A1
(43) Pub. Date: Jul. 30, 2026

(54) A FILAMENT LAMP

(71) Applicant: SIGNIFY HOLDING B.V., EINDHOVEN (NL)

(72) Inventors: RUIXIA ZHANG, SHANGHAI (CN); KEJING WANG, SHANGHAI (CN); YUNXUAN SHI, SHANGHAI (CN); DI ZHOU, SHANGHAI (CN)

(21) Appl. No.: 19/145,590

(22) PCT Filed: Dec. 20, 2023
(86) PCT No.: PCT/EP2023/086827

§ 371 Date: Jul. 3, 2025

(30) Foreign Application Priority Data
Jan. 4, 2023 (WO) PCT/CN2023/070444
Feb. 17, 2023 (EP) 23157274.4

(51) Int. Cl. F21K 9/232; F21K 9/235; F21K 9/90

(52) U.S. Cl. CPC F21K 9/232; F21K 9/235; F21K 9/90

(57) ABSTRACT

A spiral filament lamp comprising a bundle of two or more filaments. A first portion of the bundle is arranged in a helix or spiral. A second portion of the bundle extends from the first portion and into a space delimited by the helix or spiral defined by the first portion.

### FIELD OF THE INVENTION

The present invention relates to the field of lighting, and in particular to filament lamps.

### BACKGROUND OF THE INVENTION

There is an ongoing desire to improve artificial lighting. Filament lamps, such as lightbulbs, are used to provide artificial light in a wide variety of environments, such as in domestic, industrial and/or public settings.

Filament lamps currently on the market can be divided into at least three types: spiral, upright and crossing. A spiral filament lamp usually comprises a bundle of one or more filaments that is/are arranged to form a spiral or a helix, i.e., to form a spiral or helical structure. An upright filament lamp comprises a plurality of filaments that are positioned vertically with respect to the filament lamp, so that they lie perpendicularly to a socket into which the filament lamp is connected. A crossing filament lamp comprises a plurality of filaments that are inclined within the filament lamp, so that they are inclined with respect to a socket into which the filament lamp is connected.

There is an ongoing desire to the effectiveness of filament lamps.

### SUMMARY OF THE INVENTION

The invention is defined by the claims.

According to examples in accordance with an aspect of the invention, there is provided a spiral filament lamp comprising a single bundle of two or more filaments. The bundle of two or more filaments comprises: a first portion arranged to form a helix around a volume of space; and a second portion configured to extend from the first portion into the volume of space so that at least some of the second portion is located within the volume of space.

The present disclosure provides a spiral filament lamp with improved uniformity of light intensity distribution from the filament(s) alone. This avoids the need for complex and/or expensive designs of optical elements (e.g., covering bulbs) to achieve uniform light distribution. More particularly, the average relative luminous intensity of the lamp is improved with a range beginning at 0° from the axis of the helix to at least 130° from the axis of the helix. Extending the second portion into the volume of space facilitates this improved uniformity of light intensity distribution, whilst providing or maintaining a compact bundle.

The first portion is arranged to form a helix, i.e., a spiral, around a volume of space. Thus, the first portion has a helical or spiral structure. The second portion is arranged to enter a volume of space bound or surrounded by the helical or spiral structure of the first portion. This effectively increases the relative amount of light that is transmitted in directions that make a small angle (e.g., <30°) with respect to the axis of the helix.

The second portion may be formed in a curve that initially extends away from the volume of space before bending towards and into the volume of space. This provides an approach for forming the second portion without causing a sudden or significant change in direction of the bundle of two or more filaments, reducing a likelihood of breakage or damage to the bundle of two or more filaments when forming the second portion.

The second portion may be configured to extend into the volume of space by no more than the height of a single turn of the helix. This approach avoids potentially unnecessary emission of light into the volume of space (e.g., which may be at least partially absorbed by the first portion delimiting the volume). This approach also improves the uniformity of light in directions perpendicular to the axis around which the helix is formed.

In some examples, the second portion is configured to extend into the volume of space by no less than a quarter of the height of a single turn of the helix.

In some examples, the first portion and the second portion together form a continuous bundle of two or more filaments. This improves a reliability of the lamp, by reducing a number of potential points of failure. This also improves a uniformity of light output by the bundle of two or more filaments, as there is no break in the filament from which no light is output.

Optionally, the second portion is formed by a bend in the continuous bundle of two or more filaments into the volume around which the helix is formed by the first portion.

In at least one embodiment, the two or more filaments may comprise four or more filaments.

Preferably, the two or more filaments are stacked on top of one another. This increases or maximizes a surface area from which light is output by the overall bundle. This approach thereby increases a uniformity of light output by the overall lamp.

In some examples, in the first portion, the two or more filaments are stacked in a first direction parallel to the axis of the helix. This increases the uniformity of light that is output in a sidewards direction from the lamp from the first portion.

In some examples, in at least part of the second portion, the two or more filaments are stacked at a non-zero angle with respect to the axis of the helix. This approach increases the relative amount of light that is transmitted in directions that make a small angle (e.g., <30°) with respect to the axis of the helix, as there is a greater surface area facing such small angles from which light is emitted. This improves the overall uniformity of light output by the lamp with respect to different angles from the axis of the helix (e.g., increases a uniformity in a range of from 0° to 130° from the axis of the helix).

The helix may comprise at least two turns.

In some examples, the maximum width of the helix is no greater than 30 mm.

In some examples, a maximum pitch of the helix, being the height of any single turn of the helix, is no greater than 25 mm.

In some examples, a minimum pitch of the helix is no less than 5 mm.

Optionally, a total height of the helix is no less than 40 mm.

There is also proposed a method for use in manufacturing a spiral filament lamp comprising a bundle of two or more filaments.

The method comprises: arranging a first portion of the bundle to form a helix around a volume of space; and arranging a second portion of the bundle, to extend from the first portion into the volume of space.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates a first view of a spiral filament lamp;

FIG. 2 illustrates a second view of the spiral filament lamp;

FIG. 3 illustrates a top-down view of the spiral filament lamp;

FIG. 4 illustrates a relative luminous intensity over a range of angles for an existing spiral filament lamp;

FIG. 5 illustrates a relative luminous intensity over a range of angles for a proposed spiral filament lamp;

FIG. 6 illustrates labels for a spiral filament lamp; and

FIG. 7 is a flowchart illustrating a method of manufacturing a proposed spiral filament lamp.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a spiral filament lamp. The spiral filament lamp comprises a bundle of two or more filaments. A first portion of the bundle is arranged in a helix or spiral. A second portion of the bundle extends from the first portion and into a space delimited by the helix or spiral defined by the first portion.

Herein proposed approaches are based on the realization that improved uniformity of light output by a spiral filament lamp can be achieved by provision of a second portion that extends from the helically-shaped part of the bundle and into the volume around which the helically-shaped part is formed. In particular, this approach increases the amount of light that is output at relatively small angles (e.g., <30°) with respect to the axis around which the helically shaped part is formed. By causing the second portion to enter the volume, e.g. rather than terminating above or at the volume, it can be ensured that light is emitted in the full range of directions or angles not directly reached by light emitted by the helically-shaped portion, whilst still providing a relatively compact bundle of two or more filaments.

Embodiments can be employed in the manufacture or production of any suitable spiral filament lamp, having any desired shape and/or configuration to meet lighting needs or desires.

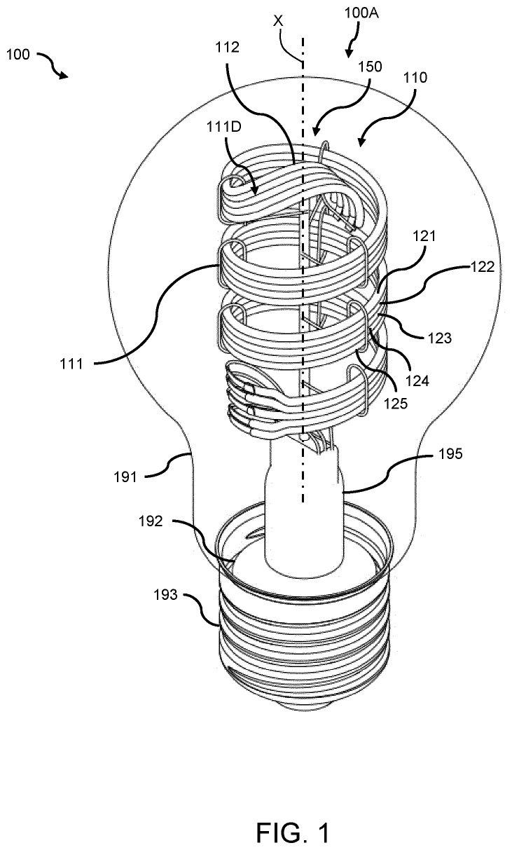

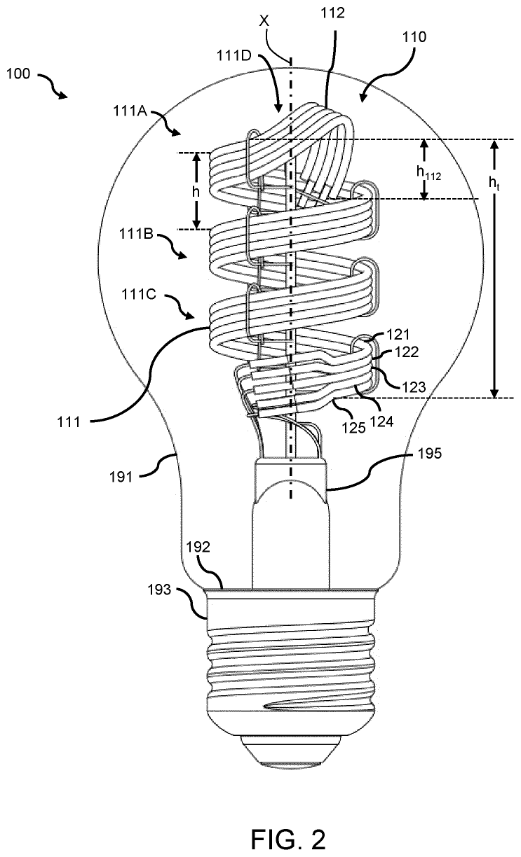

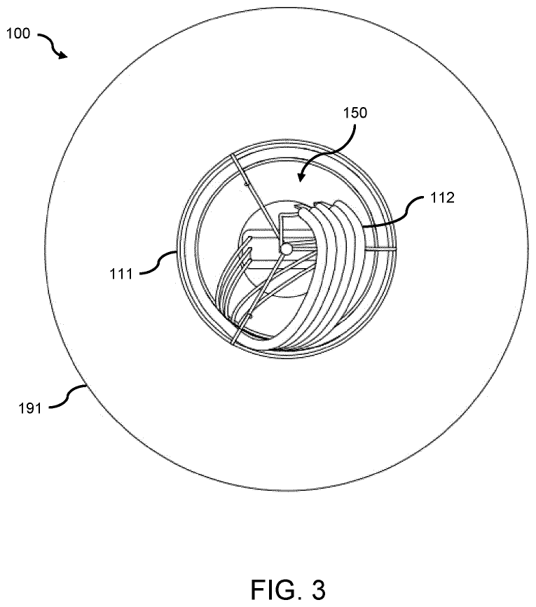

FIGS. 1 to 3 illustrate various views of a spiral filament lamp 100 according to an embodiment. FIG. 1 provides a first view of the lamp 100, FIG. 2 provides a second view of the lamp 100 and FIG. 3 provides a top-down view of the lamp 100. An alternative label for a lamp is a bulb.

The lamp 100 comprises a bundle 110 of two or more filaments 121, 122, 123, 124, 125. In the illustrated example, the bundle is formed from a single bundle of two or more filaments, particularly a plurality of filaments. A filament is an elongate element that emits light when powered. Examples of filaments include LED filaments (e.g., formed of a string of individual LEDs) or for simulating tungsten filaments in a conventional incandescent bulb. Preferably, each filament is an LED filament, for improved power efficiency and longevity.

An LED filament may be formed from a string of LEDs covered or encapsulated with a covering or protective portion. The covering portion may be continuously formed along the LED filament. The covering portion may be formed from a transmissive and/or dispersive material, e.g., a phosphor blended resin or plastics.

The bundle 110 is formed as a first portion 111 and a second portion 112.

Generally, throughout this document, reference to a bundle 110 refers to the light emitting part or section of the bundle 110, e.g., excluding any circuitry for driving, powering and/or controlling the bundle.

The first portion 111 is arranged in the form of a helix or spiral around a volume 150 of space. Thus, a cylindrical or conical volume is defined, and the first portion 111 is formed in a spiral/helix around the volume 150. The volume 150 is therefore delimited by the helical shape of the first portion 111.

The helical shape of the first portion defines an axis X. Preferably, the bundle is configured and/or positioned such that the axis X aligns with a central axis of the overall lamp. This improves an evenness of light distribution for light output by the lamp 100.

The first portion 111 may therefore be formed of one or more turns 111A, 111B, 111C. Each turn represents a loop around the volume 150 of space and the axis X. Thus, the first portion 111 is configured to wind around the first axis in a series of turns. As illustrated, the first portion is preferably formed from a plurality of turns, e.g., at least two turns, e.g., at least three turns.

The second portion 112 is extended from the first portion, e.g., from a virtual or hypothetical end 111D of the first portion. The second portion is configured to (at least partially) extend into the volume 150 of space. Thus, at least some of the second portion 112 is located within the volume 150 of space.

In particular, the light emitting part of the second portion is configured to at least partially extend into the volume 150 of space. Thus, at least some of the light emitting part of the second portion 112 is located within the volume 150 of space.

Forming the second portion 112 in this way results in an increased amount and uniformity of light output from a top 100A of the lamp 100, e.g., at angles that are relatively small (e.g., <30°) with respect to the axis X of the volume 150. This is because the parts of the filament(s) in the second portion direct light out of the top 100A of the lamp 100, as the second portion moves into the volume 150.

Configuring the second portion so that it enters the volume 150, rather than failing to do so, helps ensure that light emitted by the second portion is emitted in the full range of directions or angles not directly reached by light emitted by the helically-shaped portion (e.g., at relatively small angles with respect to the axis X of the volume 150), whilst still providing a relatively compact bundle of two or more filaments.

More particularly, and perhaps best illustrated by FIG. 2, the second portion may be configured to extend into the volume 150 of space by no more than the height h of a single turn 111A of the helix. The height of a single turn 111A can be alternatively labelled a pitch, which represents the (average) distance between any two turns of the helix.

In some examples, the light emitting part of the second portion may be configured to extend into the volume 150 of space by no more than the height h of a single turn 111A of the helix.

In some examples, the second portion is configured to extend into the volume 150 of space by no less than a quarter of the height h of a single turn 111A of the helix. Even more particularly, the light emitting part of the second portion may be configured to extend into the volume 150 of space by no less than a quarter of the height h of a single turn 111A of the helix.

Preferably, the first and second portions together form a continuous bundle of two or more filaments, i.e., there is no break or separability between the first and second portions. This improves a reliability of the lamp, by reducing a number of potential points of failure.

In the illustrated example, the first and second portion form separate parts of a/one single integral bundle of two or more filaments. Thus, the virtual end 111D of the first portion is the location or position along this single integral bundle where the first portion transitions into the second portion.

Conceptually, the second portion 112 is connected to the first portion 111 and extends therefrom. In practice, as the first portion 111 and the second portion may be formed from a single bundle of integrally formed filaments, the first 111 and second portions 112 contain different regions or zones of each integrally formed filament.

Put another way, the first and second portions may be inseparable from one another, e.g., without breaking the bundle of one or more portions. Put yet another way, the first and second portions may be formed from a bundle (e.g., a stack) of integrally formed filaments.

By way of example, if each filament is an LED filament formed from a string of LEDs covered or encapsulated with a covering portion, then there may be no break or disruption to the covering portion (i.e., it is formed from a continuous piece of material) of any filament as the bundle moves from the first portion 111 to the second portion 112.

As illustrated, the second portion 112 may comprise a bend in the continuous bundle of two or more filaments. This bend causes the second portion to be directed towards and into the volume 150 bound or delimited by the first portion 111.

As best illustrated by FIG. 2, the second portion 112 may be formed in a curve that initially extends away from the volume 150 of space before bending towards and into the volume 150 of space. Forming the second portion in a curve provides good/even distribution of light across a range of angles emitting out of a top 100A of the lamp 100, as well as reducing the likelihood of any potential damage in forming the second portion (e.g., by bending) as sudden changes in direction are avoided.

In preferred examples, the two or more filaments are stacked on top of one another. Thus, the bundle of filaments may comprise a stack of filaments arranged in an N×1 configuration, where N is the number of filaments. Thus, the width of the bundle of filaments may be equal to the width of a single filament and the height of the bundle of filaments may be N times the height of a single filament.

This approach increases the effective surface area from which light is output by the bundle of two or more filaments, increasing the uniformity of light output by the spiral filament lamp 100.

Preferably, in the first portion, the stack of filaments is orientated parallel to the axis X of the helix. Thus, the two or more filaments may be stacked in a first direction parallel to the axis X of the helix. This approach increases the amount and uniformity of light that is output sideways from the lamp 100, e.g., at angles that are relatively large (e.g., >30°) with respect to the axis X of the volume 150.

Preferably, in the second portion, the stack of filaments is oriented at a non-zero angle with respect to the axis X of the helix. Thus, the stack of filaments may be included with respect to the axis X. This increases the amount and uniformity of light output from a top 100A of the lamp 100, e.g., at angles that are relatively small (e.g., <30°) with respect to the axis X of the volume 150. This approach is perhaps best illustrated by FIG. 3.

These approaches thereby increase the overall uniformity and distribution of light across a wide/large number of angles.

The lamp 100 may further comprise a bulbous envelope 191 that covers the bundle 110 of two or more filaments. The envelope may, for instance, be formed of a transparent or translucent material that ensures illumination from the bundle 110 is capable of dissipating or being transmitted to the surroundings. Thus, the envelope may be formed from a transmissive and/or dispersive material. For example, the material of the envelope 191 may be glass or a plastic.

In the depicted embodiment, the envelope 191 has a pear-shaped cross section. More specifically, under the IEC/TR 60887:2010 standard, the envelope 191 has a shape corresponding to the letter symbol “A”. However, in alternative embodiments the envelope 191 may have a candle flame shaped cross-section, a spherical shaped cross-section, a mushroom shaped cross section, or any shaped c cross-section appropriate to house at least the bundle 110 of two or more filaments.

In the illustrated example, the lamp 100 further comprises a mount 192 that provides structural support to other elements of the lamp. The mount is therefore suitable for mechanically supporting the other elements of the lamp.

The lamp 100 may further comprise a lamp base 193. The lamp base 193 provides a means for mounting the lamp 100 to a socket (not shown) on a wall, ceiling or any other surface. In some embodiments, the lamp base may comprise a screw cap, a pin and push cap or a bayonet cap. However, embodiments are not restricted to these, and the lamp base 193 may be any means suitable for fitting the lamp 100 to a lamp receiving socket.

The first portion 111 of the bundle 110 is more proximate to the lamp base 193 than the second portion 112 of the bundle 110. More particularly, the second portion 112 of the bundle is more proximate to the top 100A of the lamp 100 than the first portion 111 of the bundle 110.

The lamp 100 may further comprise a stem 195. The stem provides wires for electrical connection for powering the two or more filaments 121, 122, 123, 124, 125 of the bundle 110. Approaches for providing such electrical connections are well known in the art.

The lamp base 193 may be appropriately configured to facilitate external powering of the (wires in the) stem 195. Thus, the lamp base may comprise one or more conductors for providing a path for power from outside of the lamp 100 to the stem 195.

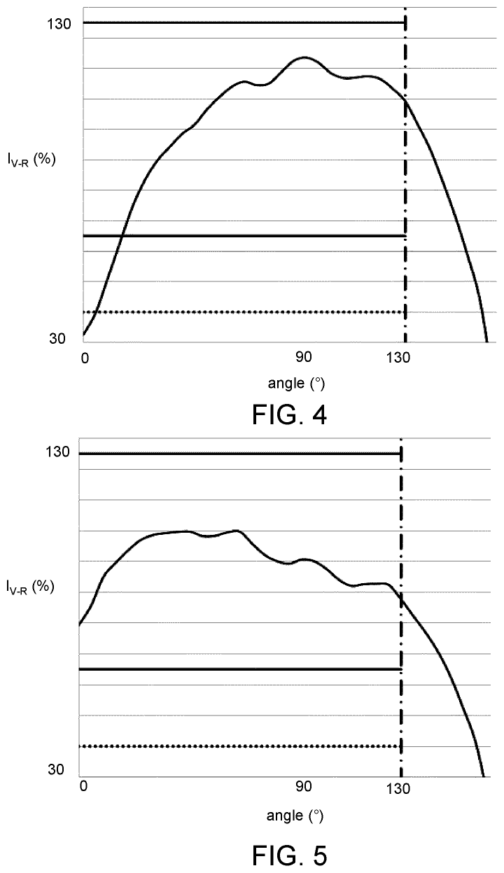

FIGS. 4 and 5 illustrate the improved uniformity of light distribution across a broader range of angles achieved by the proposed lamp.

FIG. 4 illustrates a relative luminous intensity Iv-R over a range of angles for an existing spiral filament lamp (i.e., one not comprising the second portion). The range of angles is defined with respect to the axis X, where an angle of 0° indicates light emitted out of the top of the lamp 100 along the axis X and an angle of 90° indicates light emitting out of the side of the lamp 100 perpendicular to the axis X.

It can be immediately identified that the relative luminous intensity at small angles (e.g., <30°) is extremely low. This is because the vast majority of the light emitting by an existing spiral filament lamp is directed outwards or sideways from the axis X around which the helix of the bundle is formed. This can be seen in the greater peak at an angle of around 90° with respect to the axis X.

FIG. 5 illustrates a relative luminous intensity over a range of angles for a proposed spiral filament lamp (i.e., one comprising the second portion). As before, the range of angles is defined with respect to the axis X, where an angle of 0° indicates light emitted out of the top of the lamp 100 along the axis X.

As illustrated in FIG. 5, the amount of light that is emitted at relatively low angles (<30°) with respect to the axis X is significantly increased for a spiral filament lamp according to an embodiment herein proposed. Thus, the overall uniformity of light output by the spiral filament lamp is significantly improved.

The herein proposed approach for configuring or constructing the bundle of two or more filaments thereby increases the uniformity of light output across a range of angles output by the light.

More particularly, and as illustrated by FIG. 5, the luminous intensity value varies by no more than 35% (e.g., no more than 30%) from the average of all measured values in all planes in the 0° to 130° zone. This provides a highly uniform distribution of light within the 0° to 130° zone.

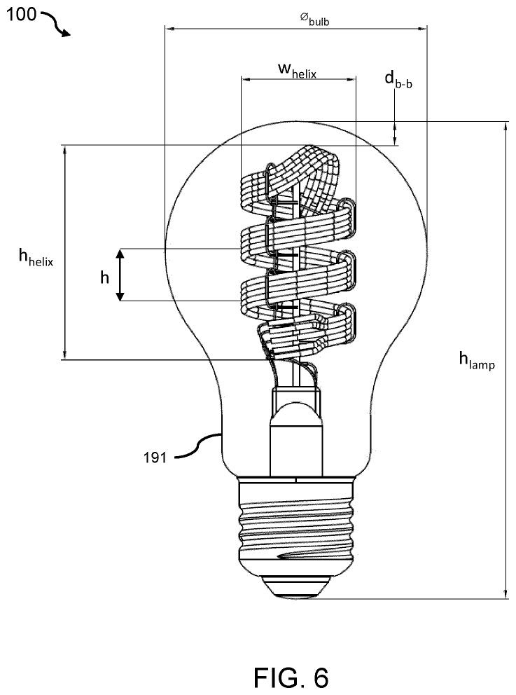

FIG. 6 provides labels for various dimensions of the lamp 100 and its features, including optional features.

The helix formed from the first portion of the bundle has a total height hₕₑₗᵢₓ. The total height of the helix is preferably no less than 40 mm, e.g., no less than 45 mm. However, the skilled person will appreciate that the height of the helix may be dependent upon the desired height of the overall lamp, which may differ dependent upon the specific use-case scenario for the lamp.

The helix formed from the first portion of the bundle has a width wₕₑₗᵢₓ. The width of the helix is preferably no less than 20 mm, e.g., no less than 25 mm. However, the skilled person will appreciate that the width wₕₑₗᵢₓ of the helix may be dependent upon the desired width of the overall lamp, which may differ dependent upon the specific use-case scenario for the lamp.

Each turn of the helix formed from the first portion has a defined height h, as previously explained. The height of each turn of the helix represents the pitch of the helix. Preferably, a maximum pitch of the helix is no greater than 25 mm, i.e., preferably the maximum height of each turn is no greater than 25 mm. Preferably, the minimum height of each turn is no less than 5 mm.

The distance between the bulb envelope 191 and the second portion of the bundle is a bundle-to-bulb distance d_{b-b}. Preferably, this distance is no less than 5 mm. This facilitates improved dispersion of light from the second portion of the bundle to improve the uniformity of light across a wide range of angles with respect to the axis of the helix.

The bulb envelope 191 has a diameter ø_{bulb}. This effectively represents a width of the bulb envelope at its thickest/largest point with respect to an axis perpendicular to the axis along which the height of the lamp is measured, e.g., perpendicular to the axis of the helix.

The height of the lamp is measured as the longest distance or dimension of the overall lamp, i.e., from the bottom of the lamp base to the top of the lamp or bulb envelope, e.g., parallel with the axis of the helix, and preferably aligned with the axis of the helix.

As previously explained, the specific dimensions of all of the features of the lamp will be dependent upon the desired use-case scenario for the lamp, e.g., to meet predetermined criteria or standards.

As a working example, the following dimensions may be used for a lamp 100 designed for use in meeting a standard A60 lamp, e.g., as set out in the IEC/TR 60887:2010 standard: hₕₑₗᵢₓ=49 mm; wₕₑₗᵢₓ=26.3 mm; h=11.5 mm; d_{b-b}=6 mm; ø_{bulb}=60 mm; and b_{height}=108 mm.

As another working example, the following dimensions may be used for a lamp designed for use in providing a standard G95 lamp: hₕₑₗᵢₓ=64 mm; wₕₑₗᵢₓ=26.3 mm; h=18 mm; d_{b-b}=15 mm; ø_{bulb}=95 mm; and b_{height}=140 mm.

As another working example, the following dimensions may be used for a lamp designed for use in providing a standard G125 lamp: hₕₑₗᵢₓ=64 mm; wₕₑₗᵢₓ=26.3 mm; h=18 mm; d_{b-b}=28.2 mm; ø_{bulb}=125 mm; and b_{height}=178 mm.

As another working example, the following dimensions may be used for a lamp designed for use in providing a standard ST64 lamp: hₕₑₗᵢₓ=64 mm; wₕₑₗᵢₓ=26.3 mm; h=18 mm; d_{b-b}=15.7 mm; ø_{bulb}=64 mm; and b_{height}=140 mm.

Naturally, the shape of the bulb envelope 191 will be appropriately modified or changed to match the desired standard for the lamp. The shape of the bulb envelope for a given bulb type (e.g., A60, G95 or ST64) is defined by the letter prefix in the bulb type, as set out in the IEC/TR 60887:2010 standard. The numbers in the bulb type define the diameter/width of the bulb envelope, as also set out in the IEC/TR 60887:2010 standard.

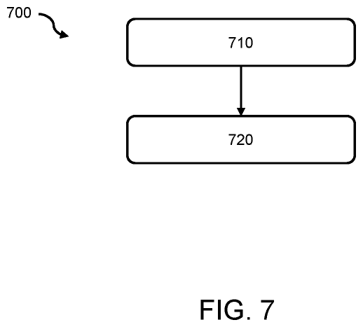

FIG. 7 is a flowchart illustrating a method for use in manufacturing a spiral filament lamp comprising a bundle of two or more filaments.

The method 700 comprises a step 710 of arranging a first portion of the bundle to form a helix around a volume of space.

The method 700 also comprises a step 720 of arranging a second portion of the bundle to extend from the first portion and into the volume of space.

The skilled person would be readily capable of adapting the method 700 to produce any herein disclosed spiral filament lamp, e.g., providing additional steps for defining the other features of the spiral filament lamp where required. The method 700 can be integrated into existing lamp manufacturing techniques, e.g., to replace or supplement previous approaches to providing or defining a bundle of two or more filaments of a spiral filament lamp.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A spiral filament lamp comprising a single bundle of two or more filaments, the bundle of two or more filaments comprising:
a first portion arranged to form a helix around a volume of space; and
a second portion configured to extend from the first portion into the volume of space so that at least some of the second portion is located within the volume of space;
wherein the first portion and the second portion together form a continuous bundle of two or more filaments;
wherein a light emitting part of the second portion is configured to extend into the volume of space by no more than the height of a single turn of the helix.

2. The spiral filament lamp of claim 1, wherein the second portion is formed in a curve that initially extends away from the volume of space before bending towards and into the volume of space.

3. (canceled)

4. The spiral filament lamp of claim 1, wherein the second portion is configured to extend into the volume of space by no less than a quarter of the height of a single turn of the helix.

5. The spiral filament lamp of claim 1, wherein the second portion is formed by a bend in the continuous bundle of two or more filaments into the volume around which the helix is formed by the first portion.

6. The spiral filament lamp of claim 1, wherein the two or more filaments comprises four or more filaments.

7. The spiral filament lamp of claim 1, wherein the two or more filaments are stacked on top of one another.

8. The spiral filament lamp of claim 7, wherein, in the first portion, the two or more filaments are stacked in a first direction parallel to the axis of the helix.

9. The spiral filament lamp of any of claim 7, wherein, in at least part of the second portion, the two or more filaments are stacked at a non-zero angle with respect to the axis of the helix.

10. The spiral filament lamp of claim 1, wherein the helix comprises at least two turns.

11. The spiral filament lamp of claim 1, wherein a maximum pitch of the helix, being the height of any single turn of the helix, is no greater than 25 mm.

12. The spiral filament lamp of claim 1, wherein a minimum pitch of the helix, being the height of any single turn of the helix, is no less than 5 mm.

13. A method for use in manufacturing a spiral filament lamp comprising a single bundle of two or more filaments, the method comprising:
arranging a first portion of the bundle to form a helix around a volume of space; and
arranging a second portion of the bundle, connected to one end of the first portion of the bundle, to extend a light emitting part of the second portion into the volume of space by no more than the height of a single turn of the helix.
